(19) United States
(12) Patent Application Publication
(10) Pub. No.: US 2009/0316012 A1
(43) Pub. Date: Dec. 24, 2009

(54) Method of processing multiple video images

(76) Inventor: Jeffrey A. Matos, New Rochelle, NY (US)

Correspondence Address: ECKERT SEAMANS CHERIN & MELLOTT, LLC, U.S. STEEL TOWER, 600 GRANT STREET, PITTSBURGH, PA, 15219-2788, US

(21) Appl. No.: 12/214,663

(22) Filed: Jun. 21, 2008

(51) Int. Cl. H04N 5/228

(52) U.S. Cl. 348/208.14; 348/E07.001

(57) ABSTRACT

A method of storing and organizing digital images includes the steps of:

a) using a camera, creating a digital image consisting of visual data representing visual content of a scene;

b) storing the visual data along with additional information which indicates a position of the camera and a spatial orientation of the camera at the moment when the digital image is created;

c) moving the camera to another location and repeating steps a) and b);

d) repeating step c) until the desired amount of information is obtained.

The camera can be moved intermittently, or moved continuously, while repeatedly capturing the visual data relating to the scene. Once captured and stored, the digital images can be compared to analyze the content of the scene.

### CROSS-REFERENCE TO RELATED APPLICATION

This present application claims benefit of priority from U.S. Provisional Application Ser. No. 60/936,494, filed Jun. 20, 2007, entitled “DISPLAY OF EITHER REAL TIME OR ARCHIVED VIDEO INFO FOR A REMOTE VIEWER”.

### BACKGROUND OF THE INVENTION

Methods of archiving visual information are more complex than methods of archiving text data. Text information may be considered to be generally one-dimensional, i.e. one character follows the next. Branches may occur (e.g. footnotes and other references within the text).

Visual information, on the other hand, is generally at least two dimensional. A single image of a scene, from one eye or one camera, would contain two-dimensional information. Three-dimensional information is required to archive and construct the actual scene—e.g. buildings, mountains etc. The archiving of such visual information presents a greater challenge because of the multidimensional aspect of the data.

### SUMMARY OF THE INVENTION

One invention herein concerns the generation of a map of a scene by recording images of a scene taken from different vantage points, labeling the images, according to (i) the site of the recording and, optionally, (ii) according to certain additional information. The recording may occur from a single camera, or from multiple cameras. Terrain maps may thus be generated corresponding to the view from the camera.

The invention may also be used as an entertainment device, i.e. for taking a virtual trip through an already mapped terrain.

Another aspect of the present invention concerns the generation of three dimensional data from two dimensional images, and the techniques of archiving such data.

Yet another aspect of the present invention concerns the comparison of images of the same scene recorded at different times. This aspect of the invention may be used for a variety of purposes including the determination of a change in a terrain, a change in an urban setting, and a change in a body part, including the face. In the latter application, it may guide the application of makeup or other cosmetic products to the face.

### BRIEF DESCRIPTION OF THE DRAWINGS

FIG. 1 shows a flow diagram of a method of storing digital images.

FIG. 2 shows apparatus for continuously or semi-continuously recording digital images of a terrain, using a single camera.

FIG. 3 shows apparatus for continuously or semi-continuously recording digital images of a terrain, using two cameras.

FIG. 4 shows a method of calculating the distance to a distant point, using known trigonometric relationships.

FIG. 5 shows a representational view of the extrapolation of the distance to distant points.

FIG. 6 shows a tabular display of a method of creating digital files showing successive camera positions and other data.

FIG. 7 shows a tabular display of a method of creating digital files showing successive camera positions and distance to an observed point.

FIG. 8 shows a tabular display of a method of creating digital files showing the location of objects of interest in three dimensional space.

FIG. 9 shows a tabular display of a method of creating digital files showing a complete map of a three dimensional space.

FIG. 10 shows a representational view of a multiscreen display.

FIG. 11 shows a schematic view of a multiplicity of possible paths that may be taken by a vehicle traversing a route between two fixed points.

FIG. 12 shows a flow diagram of a method of detecting a comparing changes in a scene that have taken place over an interval of time.

FIG. 13 shows a representational view of a method of comparing changes in a scene that have taken place over an interval of time.

### DETAILED DESCRIPTION OF THE PREFERRED EMBODIMENTS

A simple approach to the processes herein may be considered to entail the steps of:
1) Recording the visual information; and
2) Storing the visual information.

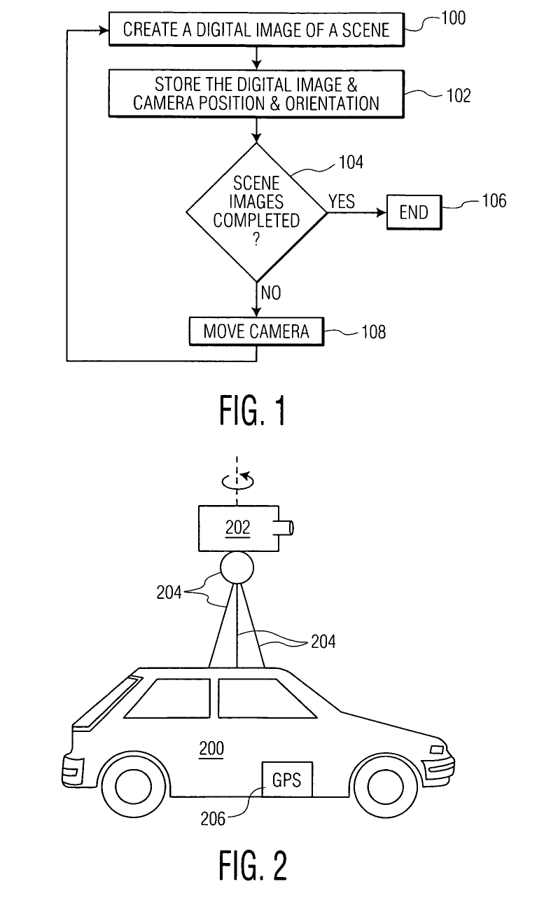

This approach is shown in the flow diagram of FIG. 1. An digital image of a scene is created using a camera, block 100. The image is stored, block 102, along with data which indicates (a) the location of the camera at the time of the recording, and (b) the orientation of the camera at the time of the recording. Using techniques known in the art, the data indicating the location of the camera and its orientation may be (i) within the information file, (ii) part of the label/name of the file, or (iii) both (i) and (ii).

The camera is then moved and the processes described hereinabove for blocks 100 and 102 is repeated. In a preferred embodiment of the invention, the camera is moved an amount which is small enough so that there are no gaps in the view of the scene when adjacent images are assembled. 100 and 102 are repeatedly performed. If, after multiple such performances, the desired information has been obtained, block 104 leads to 106, and the recording process is complete. Until it is complete, block 104 leads to 108, wherein the camera is moved, and the recording (block 100) and storage (block 102) processes repeat.

FIG. 2 shows an example of a simplified apparatus for the performance of such recording, including a movable vehicle 200 with vehicle-mounted camera 202, and mounting apparatus 204. The vehicle may contain a Global Positioning System 206, to facilitate the labeling of images with position information. Alternatively, position information may be:

a) obtained if the vehicle moves on a fixed track by markers (either visual, electronic, mechanical, RF) in the vicinity of the track;

b) obtained if the vehicle moves on a known road or route by markers (either visual, electronic, mechanical, RF) in the vicinity of the road or route;

c) determined if the vehicle moves at a known speed on a track;

d) determined if the vehicle moves at a known speed on a road or route; or

e) obtained or determined by combinations of a)-d) hereinabove.

202, in a preferred embodiment of the invention, is mounted so that its orientation may be altered:

a) by rotation around a vertical axis, i.e. in the right-left direction,

b) by rotation in the up-down direction, or

c) both a) and b).

In addition, the camera may be caused to move [by translational motion] further up or down.

Changes in camera position or orientation may be executed by:

a) an on-scene, human camera operator,

b) a remotely located human camera operator [with commands for camera position transmitted by (i) a hard-wired connection, (ii) a telephone system connection, (iii) a RF connection, or (iv) an internet connection],

c) an on-scene or remotely located computer, which (i) moves the camera in a methodical fashion so as to include certain pre-selected scenes and or certain viewing angles, and/or (ii) may detect certain cues [e.g. a moving object] and, in response to them, cause the camera [and or the vehicle] to preferentially be positioned to spend a disproportionately large amount of time viewing an object of interest.

Vehicle 200 may be (i) self propelled, (ii) moved by an outside agent [e.g. by a locomotive, a pulley system, etc.] or (iii) may be moved by inertial/gravitational forces [e.g. a satellite]. It may be land based [an automobile, truck, train], water based [a boat or submarine] or air-based [airplane, rocket, balloon, satellite].

Changes in vehicle position, velocity, acceleration or deceleration and orientation may be executed by:

a) an on-scene, human driver,

b) a remotely located human driver [with commands for vehicle motion transmitted by (i) a hard-wired connection, (ii) a telephone system connection, (iii) a RF connection, or (iv) an internet connection],

c) an on-scene or remotely located computer, which (i) moves the vehicle in a methodical fashion so as to include certain pre-selected scenes and or certain viewing angles, and/or (ii) may detect certain cues [e.g. a moving object] and, in response to them, cause the camera [and or the vehicle] to preferentially be positioned to spend a disproportionately large amount of time viewing an object of interest.

Camera 202 may be outfitted with a variety of controls of video image acquisition including (i) focus, (ii) optical zoom, (iii) iris opening, (iv) filtering, (v) white level, (vi) choice of lens, (vii) frame rate, and (viii) bits per frame. The choice of each of these may be made (a) by a local human operator, (b) by a remote human operator, or (c) by a computer/microprocessor with either a fixed program, or a program which is responsive to local or other conditions.

Video images may be digitized in any of the formats known in the art. The format may also be selected locally, remotely, or may be pre-programmed.

The mechanisms for vehicle propulsion, changes in camera position and angulation, changes in camera controls are not shown in the figure, but are well known in the art.

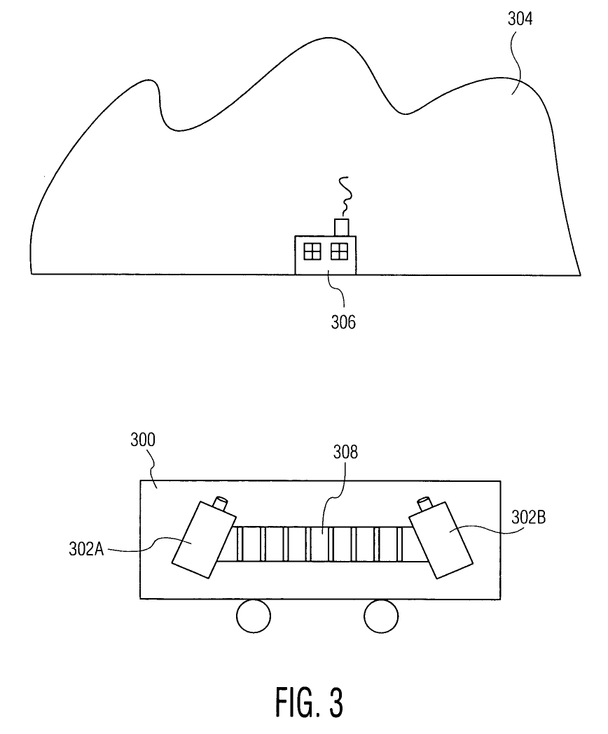

FIG. 3 shows a camera supporting vehicle 300 which contains two cameras, 302A and 302B. The vehicle is shown moving past a scene with a mountain 304 and house 306 to be recorded/mapped. The value of two cameras is:

a) it facilitates a binocular representation of a scene; and

b) it facilitates the calculation of the distance to an object (discussed hereinbelow).

The distance between 302A and 302B may be fixed or variable. In an exemplary embodiment of the invention, one or both cameras may move along a track 308. The cameras may also move (i) perpendicular to the line between them, on the surface of the vehicle, or (ii) in the up-down direction. Furthermore, the location of 302B may be directly above that of 302A. 302A and 302B may be the same camera or may be different ones.

Each of the options for vehicle choice, vehicle control and, camera control discussed in conjunction with the one-camera embodiment of the invention is applicable to the multi-camera embodiment. The control settings for 302A may be the same as or different from the settings for 302B.

Although FIG. 3 shows two cameras, embodiments of the invention with 3 or more cameras are possible. The cameras may be placed along a single line or may not be. Two or more of the cameras may point in (i) the same direction, (ii) nearly the same direction, (iii) different directions, or (iv) combinations of (i), (ii) and (iii).

### Distance Information:

Each recording formats may or may not include information which specifies the distance between the camera and an object which is being viewed. Distance information may be obtained by:

a) radar, or other energy reflection means involving transverse waves;

b) ultrasound (i.e. bouncing ultrasound waves of an object), or other energy reflection methods involving longitudinal waves;

c) triangulation. In this approach, a fiduciary point (“FP,” e.g. a corner of a building) is selected, and the angle corresponding to the FP recording is noted. When the moving vehicle, “MV”, has moved a known distance, the angle is again measured, allowing calculation of the position of the FP (assuming that the FP is in the same location at the time of each of the two measurements); and by

d) combinations of A)-C).

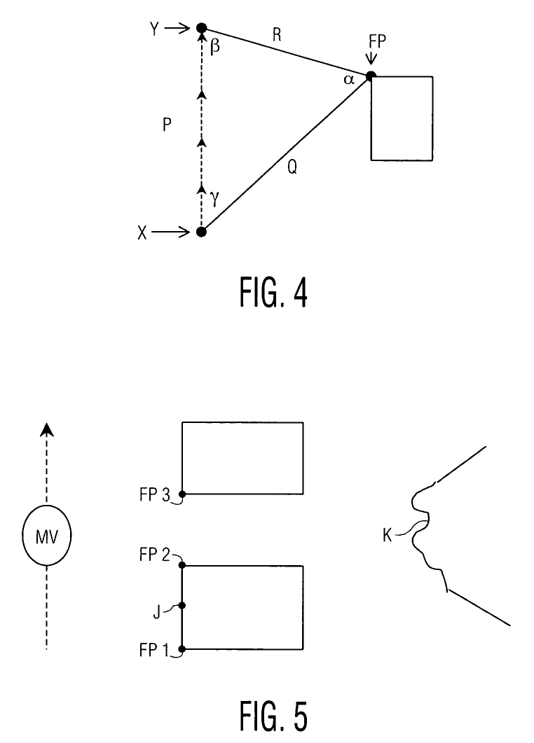

A two dimensional version of the distance determination is shown in FIG. 4.

In the example above, a vehicle moves on flat terrain from Point X to Point Y. (The example can also apply to observations from an aircraft, where the distance from X to Y is determined by global positioning apparatus, as is known in the art.) The position of the FP is calculated as follows. The law of sines tells us that

P/sin=Q/sin=R/sin γ

### Therefore:

Q=(P) (sin β/sin (180°-β-γ) and R=(P) (sin γ)/sin (180°-β-γ)

Alternatively, instead of measuring each of γ, β, Q and R as the vehicle travels from X to Y, these four measurements could be made:

1) by the same vehicle during two different trips, or during a trip in which it does not move directly from X to Y;

2) by two different vehicles, either at the same time or at different times; or

3) by a single vehicle with two cameras which are separated by sufficient distance such that the measurement may be made simultaneously.

Furthermore, there may be multiple determinations of the position of the FP as the camera-bearing MV moves from Point X to Point Y. These values may be averaged (in the strict arithmetic sense of the term), or the position data may be refined using other techniques which weight the value of each distance measurement, as are known in the art.

Assumptions in the above model include:

1) It applies to a 2 dimensional situation, e.g. observations made on a flat terrain, with a camera angle that involves 0 degrees of elevation from the horizontal. However, the model can be extended to 3 dimensions. One way to make the 3 dimensional measurements would be to measure the angle of elevation (to be referred to as μ) when the camera is at point X and aimed at the FP, and to again measure the angle of elevation (to be referred to as ν) when the camera is at point Y and aimed at the FP. The orientation of line XY, the position of point X, the angle γ and the angle μ, in combination, define a unique line in 3 dimensional space. Similarly, the orientation of line XY, the position of point Y, the angle β and the angle ν, in combination, define a second unique line in 3 dimensional space. The two aforementioned unique lines will intersect (if the measurements are perfectly made and if the fiduciary point does not move between the time of the first and the time of the second measurements). To those skilled in the mathematical methods involved herein, 1) the calculations for the distance to the FP (from each of X and Y) in the 3 dimensional case and/or the location of the FP will be clear; and 2) variations in the definition of the angles involved in the measurements, as well as other mathematical variations, will be clear.

2) The figure and calculations which illustrate triangulation entail the assumption that the camera aperture is infinitely small, and that the observation is along an infinitely thin line. In reality, the camera image is a (three dimensional image projected onto a) two dimensional object. Because of this, a correction will have to be introduced into β and γ for right-left deviations of the position of the FP from center screen, and into μ and ν for up-down deviations of the position of the FP from center screen. The method of calculating these corrections will be apparent to those skilled in the art.

3) It applies to situations in which the FP is stationary during the time between the measurement at Point X and the measurement at Point Y. If the FP is non-stationary, then the shortest interval of time between measurements will result in the smallest FP movement. On the other hand, if the MV is moving slowly, and/or if the FP is distant, then a short inter-measurement interval makes the accuracy of the FP heavily dependent on the accuracy of each of the angular measurements. The tradeoff between (a) closely spaced measurements more heavily dependent on measurement accuracy, and (b) less closely spaced measurements which allow for greater FP movement, will be best assessed by those familiar with the system design (and measurement accuracy), the expected or tolerable amount of FP movement, and the speed of MV movement.

4) It assumes that a discrete, small unequivocally viewable FP may be defined: If, when the MV is at point Y, at the time of the second attempted FP sighting, a point other than the true FP (as defined by the first sighting from Point X) is felt to be the true FP, errors will result. As in the case of 3) immediately above, a short distance between Point X and Point Y makes FP mis-identification less likely, but increases the burden of other inaccuracies due to a short distance between Point X and Point Y.

5) For points which lie between FPs, extrapolation may be used with variable degrees of success, as shown in FIG. 5. In the figure, although the position of Point J may be defined accurately by linear extrapolation based on the location of FP 1 and of FP 2 (each determined by the MV), the position of Point K may not be defined accurately by linear extrapolation based on the location of FP 2 and of FP 3. In such circumstances, another method of distance measurement (e.g. radar) could be used to supplement the triangulation information.

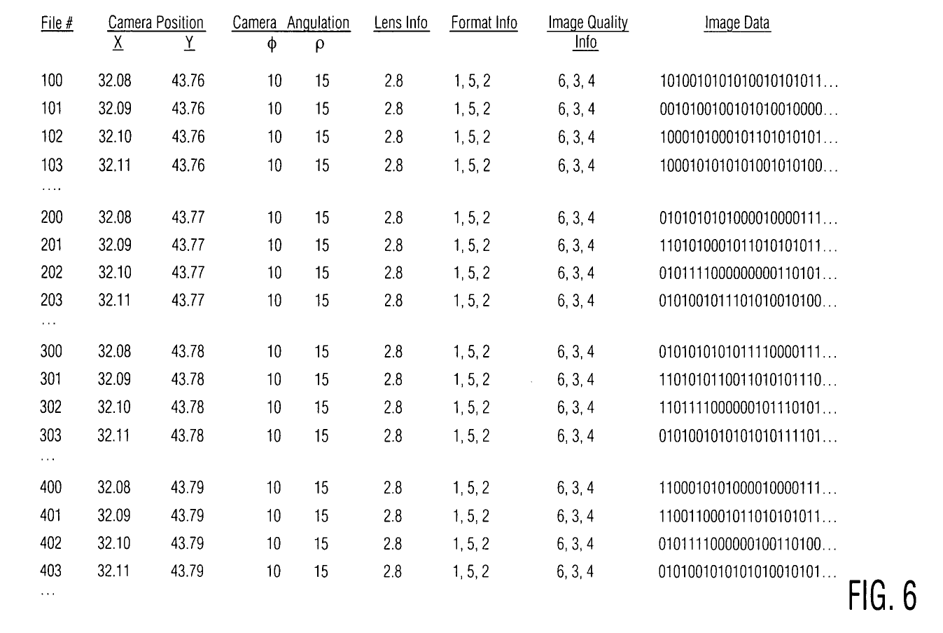

FIG. 6 shows one of many possible methods of data formatting. The method shown in FIG. 6 uses camera position as the primary parameter of data file labeling. The first line of exemplary data shows that with the camera at a position with grid coordinates X=32.08 and Y=43.76, the image held in file #100 is recorded. In the example, camera angulation information, lens information, format information and image quality information are also stored in file 100.

An image may have next been recorded after the camera was moved slightly along the X coordinate, such that, after the move, the new X coordinate was 32.09, and the Y coordinate was unchanged at 43.76. All other camera parameters are shown, in the example, to be unchanged. In FIG. 6, the image data shown for file #101 contains this information.

As the camera continues to move along the X coordinate: file #102 with X coordinate 32.10 and the associated image data is recorded, file #103 with X coordinate 32.11 and the associated image data is recorded, etc. This process continues for the duration selected by an operator, either remote or distant, human or programmed, in real time or otherwise.

Camera angulation data is shown in the figure. In this example, the camera orientation is specified by two angles, one indicating elevation above the horizontal plane, and one indicating rotation about a vertical axis. Information about lens opening is also catalogued. Formatting information may indicate one or more parameters such as filtering, white level, choice of video format (e.g. JPEG vs others), etc. Image quality information may indicate resolution, frame rate, data compression etc. The image data is the actual video data. Embodiments of the invention with larger or smaller numbers of file information categories are possible. Still other formats will be obvious to those skilled in the art.

In an embodiment of the invention with two cameras, in which data is formatted according to the style of FIG. 6, one set of data for each camera would be present.

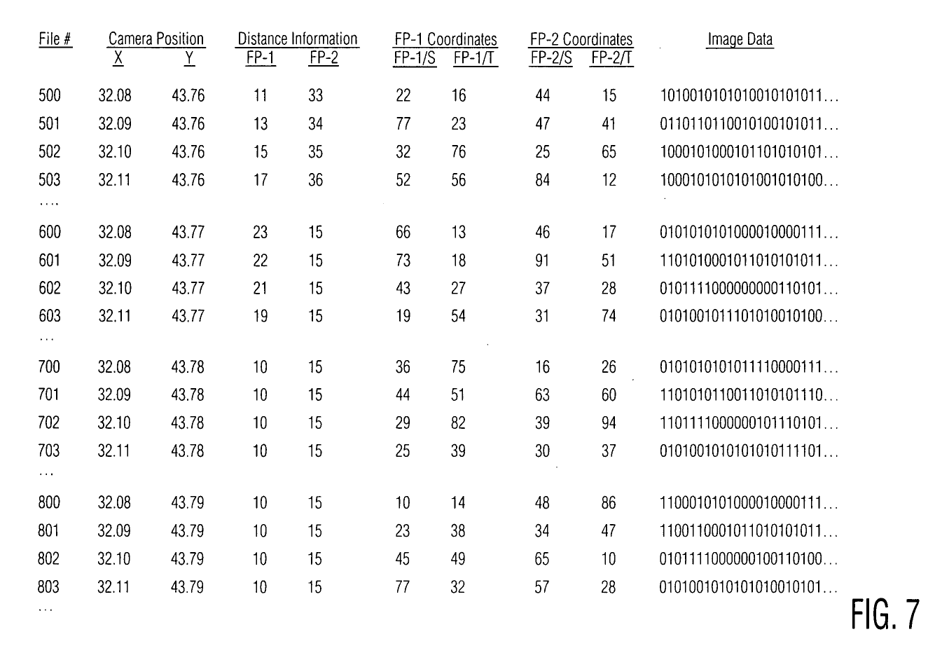

FIG. 7 shows another method of data formatting. As in FIG. 6, the method shown in FIG. 7 uses camera position as the primary parameter of data file labeling; however, the position of one or more selected points within the image, the FPs, is used to indicate the distance to one or more objects within an image. The distance to the FP may be determined by either (i) triangulation, using a single camera which records an image containing the FP, from two different locations at different times, (ii) using two cameras, each of which records an image containing the FP, from two different locations, at approximately the same time [Two cameras at different times amounts conceptually to the same case as (i), herein.], or (iii) by using the transit time of either a radar or other energy wave from an output transducer to a receiver to measure the distance to the object. In the FIG. 7 format, an image is recorded at each camera position, the position indicated by an X and a Y coordinate. If a first fiduciary point, i.e. FP-1, is identified in the image, the distance between the camera and FP-1 is calculated (as discussed hereinabove) and is included in the file. Though FIG. 7 shows an example of two FPs, each image may have none, one, or more than one FP.

Since the FP will not necessarily be located in the center of the image, a correction will be necessary for off-center FPs. Referring to FIG. 4 and the associated calculation of Q and R hereinabove, the effect of an off-center FP when an image is recorded from figure X will require that a small correction to angle γ be made. The correction will be a function of:

(i) the amount by which the FP is off-center in the image; and

(ii) the distance from the camera to the object. It may be calculated using basic trigonometric principles which will be familiar to those skilled in the art. Clearly, the larger the value of the distance from camera to object, the smaller the correction.

In FIG. 7, the amount by which the FP is off center in the image is indicated by two coordinates: “S” and “T”. Thus line 1 shows that the FP has an S coordinate of 22 within the image and a T coordinate of 16. Many coordinate systems are possible, which assign a unique coordinate to each possible fiduciary point position within an image.

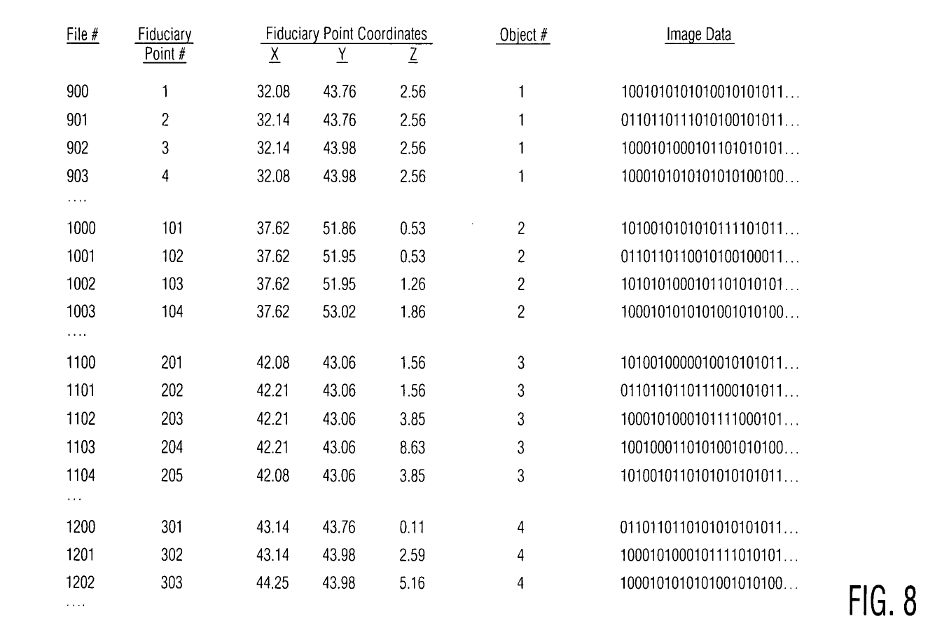

Referring to FIG. 4, once distance value Q is available for a fiduciary point, the position of the FP in space may be calculated using (i) the value of Q, (ii) the position of point X and (iii) angle γ (and, the elevational angle μ, if necessary). By using the calculated positions of FPs, another data formatting method, shown in FIG. 8, is possible. This method presents visual data by cataloging either fiduciary points, or objects composed of one or more FPs. In the example shown in FIG. 8, the X, Y and Z (Cartesian) coordinates of each FP are calculated. A file is maintained for each FP which contains information about (i) the position of the FP, and (ii) the image of the FP. Optionally, the file may also contain: (i) information indicating an object to which a particular FP belongs, and (ii) other imaging data not shown in the figure (e.g. the camera(s) and camera position(s) and orientation(s) when the images which determine the FP were recorded. The determination of which FPs belong to which object may be based on the presence of lines, curves or simple geometric shape edges “fitting” with the positions of the FPs. The determination of the FP-object relationship is subject to the same “optical illusions” that impose themselves on the human eye-brain combination.

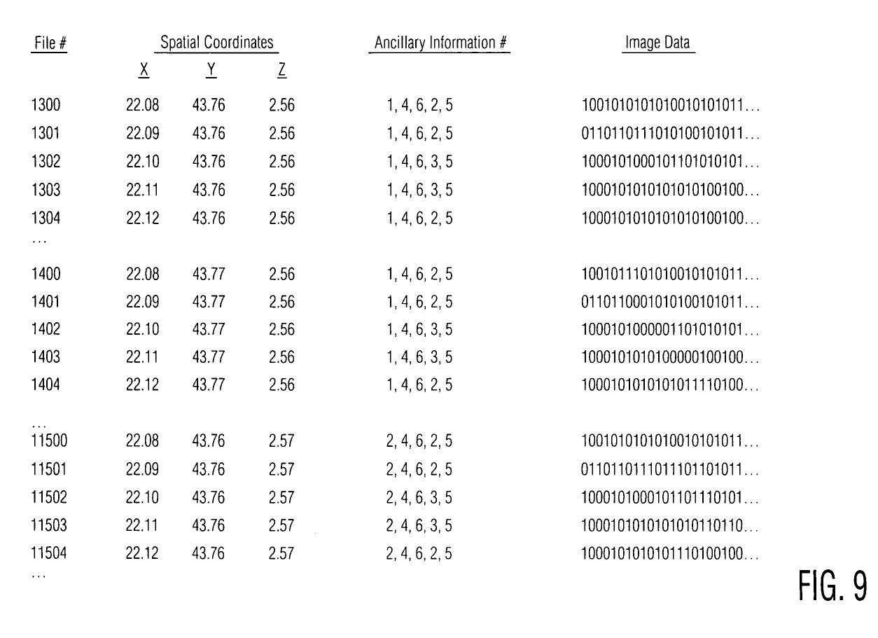

FIG. 9 shows a method of video data formatting which uses a plurality of distance measurements to generate a three dimensional image of a terrain. In the example shown, files 1300 through 1304 contain a succession of images (represented as a series of 0's and 1's in the “Image Data” column) in which both the Y and the Z coordinate are constant, and in which the X coordinate fluctuates by 0.01 arbitrary distance units, with each successive file. Files 1400 through 1404 show (i) the same progression in X values as files 1300 through 1304, (ii) a constant value of the Y coordinate which is 0.01 arbitrary units greater than that of the points in files 1300 through 1304, and (iii) a constant value of Z coordinate. The “Ancillary Information” may include any of the aforementioned additional parameters such as a time stamp, an indication of ambient lighting, camera settings, etc.

Coordinate systems other than Cartesian may be used to label positions in 3 dimensional space, including but not limited to spherical coordinates and cylindrical coordinates. Coordinate systems other than Cartesian may be used to label positions in 2 dimensional space, including but not limited to circular coordinates.

Though FIG. 6 and FIG. 9 both show a plurality of image files which are labeled in conformity with scene geometry, the difference between the two is:

FIG. 6 shows the image data arranged according to its appearance by a moving observer. Distance information is not shown, and unless further processed, the images can only be used to reproduce the scene as viewed by the original moving observer/camera.

FIG. 9 shows the image data arranged according to its three dimensional spatial location. These images, if present in sufficient quantity could be used to generate views of the scene from vantage points which were not traversed by the original moving observer/ camera.

Many display formats are possible for viewing the aforementioned information. The simplest approach is a single video monitor which reproduces the images obtained from a single camera. The reproduction may be real-time, i.e. simultaneous with the recording of the image, or it may be archived data.

When two cameras are used, and oriented to attempt to reproduce binocular vision, “virtual reality” goggles may be used in conjunction, with each eye seeing one camera view.

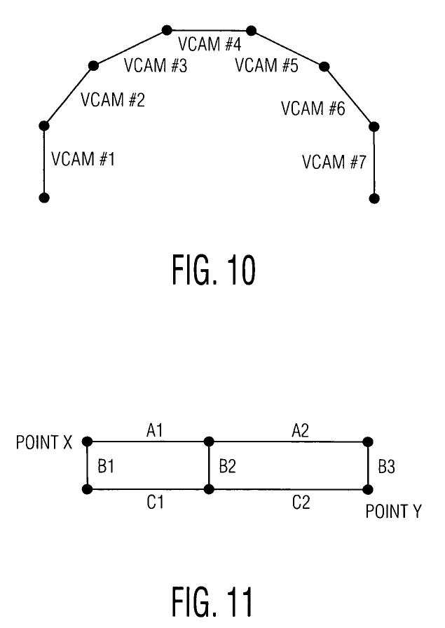

When multiple cameras are used, a simple approach analogous to the aforementioned, uses multiple video monitors, each assigned to a single camera. If the monitors are arrayed to reproduce the orientation of the cameras, and if the cameras are oriented to span a terrain, without overlap, at regularly spaced angles, then a multi-element screen such as that shown in FIG. 10 may be used. In the figure, the screen segment labeled VCAM #1 would be used to show the images recorded by a first video camera; the screen segment labeled VCAM #2 would be used to show the images recorded by a second video camera, etc. As the number of screen segments and video cameras gets large, the screen will appear to be curved. The curve may be circular in shape, elliptical, or another shape.

FIG. 11 shows a use of the invention for virtual navigation of a terrain that has been previously traversed by the video recording apparatus. Recordings are made by one or more cameras which move along each of segments A1, A2, B1, B2, B3, C1 and C2. Thereafter, the terrain between point X and point Y may be viewed along any of the following routes:

(i) A1 to A2 to B3;

(ii) A1 to B2 to C2; and

(iii) B1 to C1 to C2.

Data formatted according to the format shown in FIG. 6 is ideally suited for such a virtual trip. The trip could be for entertainment purposes, or for real estate, government or military purposes. The driver could have access to a control panel which allows for making elective turns (e.g. at the junction of A1, A2 and B2), for zooming in, changing lighting, etc. The choice of routes could be far more complex than that shown in FIG. 11: larger data banks would allow for a potentially limitless number of routes. Furthermore, data in the format shown in FIG. 9—entailing an actual terrain map, rather than a mosaic of terrain images—would potentially allow for “off road” navigation: The virtual driver would not be required to stick exactly to the path and viewing angle used by the recording camera.

### Tracking Video Changes:

Hereinabove, the invention has entailed changes in a scene over space. Another aspect of the present invention documents the changes in a scene over time.

All recorded images are date and time-stamped. For a particular location or view, the video data recorded at time #1 (by any of the aforementioned methods) can be compared to video data recorded at time #2. The video data management techniques discussed hereinabove in relation to the archiving and processing of spatially distributed video information may be used in conjunction with the temporal comparisons discussed herein.

A comparison of a particular location at two different times can detect changes such as personnel or vehicle movement, changes in agricultural or foliage patterns, astronomical changes, changes in the internal, external or radiologic appearance of a body part, changes in the application of makeup or in the faithfulness of reproduction of a cosmetic “makeover.” Yet another use of the system would be to match as accurately as possible, two visual images thought to be those of the same person, so as to confirm the identity of the person. The image could be of a face, an iris, a retinal pattern, an iris pattern and/or one or more fingerprints or palmprints.

For example: A person could have makeup applied to the face by a professional makeup artist, in a way that they deem to result in the most desirable appearance. One or more initial images of this initial appearance could be entered into a digital memory by a digital camera. At a later time, when the person desires to reproduce the initial desirable appearance, they make an attempt to do so, enter the later image(s) associated with the event into a digital memory, and use a computer/ microprocessor to detect and indicate areas of the face (or other body parts) that differ from the initial image(s). The system could notify the individual of suggested products and techniques in order to reproduce the initial image.

The process could be an iterative one:

a) initial image is obtained;

b) a first later image of a first later appearance is obtained and is compared with the initial image;

c) suggestions are made by a computer with techniques and instructions aimed at changing the first later appearance so that it duplicates the initial appearance;

d) following the execution of some or all of the aforementioned instructions, a second later image is obtained and is compared with (i) the initial image and (ii) optionally, the first later image;

e) additional suggestions are made by the computer with techniques and instructions aimed at changing the second later appearance so that it duplicates the initial appearance (and possibly commenting on the extent of success or lack thereof in carrying out the instructions in step c).

Steps analogous to d) and e) may be repeated until either the user is satisfied or decides not to go on.

Another use of the invention is the detection of changes in an image generated by a medical examination. Such images include:

a) ultrasound images of a substantially stationary organ, e.g. the kidney;

b) ultrasound images of a moving organ, e.g. the heart;

c) X-Rays—e.g. a chest X-Ray;

d) a CT (computed tomography scan);

e) an angiogram;

f) a mammogram;

g) a magnetic resonance image;

h) images from a “pill-camera”; and

i) photographs of a skin lesion.

Various display formats can be utilized, e.g.
a format which emphasizes the images which are present only at time #2, and de-emphasizes all other images;
a format which emphasizes the images which are present only at time #1, and de-emphasizes all other images;
a format which lists and/or displays only those images or regions which show a change over time.

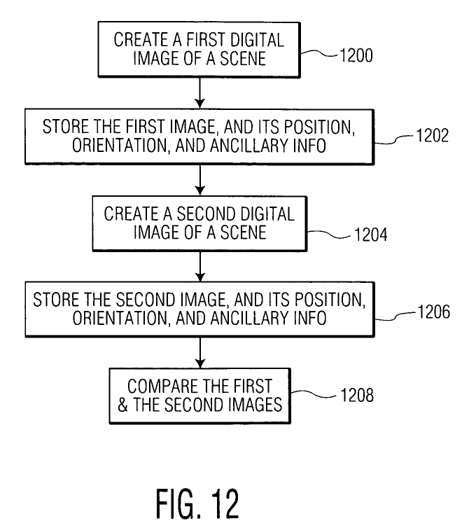

FIG. 12 is a flow diagram showing the basic steps of a method of storing video information so that time dependent changes in a scene may be detected. At block 1200, a first digital image of a scene is created. At block 1202, the first image is stored along with information that allows for recording of the image at a later time under nearly identical conditions (e.g. camera placement and orientation, lighting, etc.). At a later time than that of the image acquisition of block 1200, and under as nearly identical recording conditions as possible, a second digital image of the scene is created, block 1204. At block 1206, the second image is stored along with ancillary information similar to that in block 1202, to facilitate comparison with the first image. At block 1208, the first and second images are compared.

Identification of at least one fiduciary point in the images makes the task of superimposing them easier, and identification of two such points would, if magnification and camera position and orientation were identical for both recordings, allow for an exact superimposition (assuming that the position of the FP had not changed between the times of the two image acquisitions). Identification of multiple FPs will also facilitate corrections for changes in magnification and orientation of the two images.

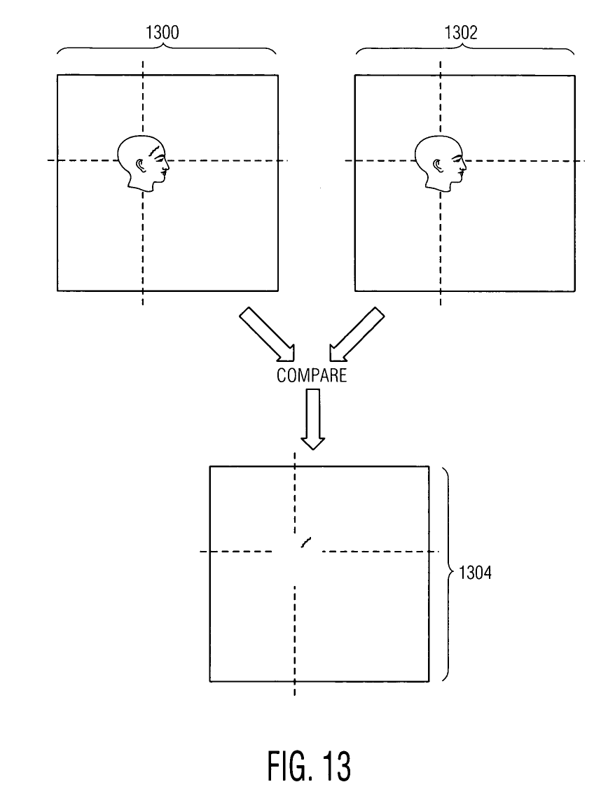

FIG. 13 shows a view of a person using the system to compare images of the face made at separate times. Image 1300 shows the baseline facial image, with a small scar on the right cheek. Image 1302 shows a nearly identical image, without the scar. Image 1304, shows a subtraction image, that is the image at t=1 minus the image at t=2, showing only the scar. Broken lines in each figure show the position of the scar.

FIG. 13 shows a two camera version of the system. Embodiments of the invention are possible (i) with one camera; and (ii) with more than two cameras.

Embodiments of the invention are possible which are a hybrid of (i) the method of archiving a mosaic of spatial information described hereinabove, and (ii) the method of detecting changes in a scene over time. The hybrid system would allow for the comparison of (i) video data in one of the formats of FIGS. 6, 7, 8 or 9 at one instance in time with (ii) identically formatted data at a later instance in time.

The system could be formatted to notify an individual in the event of a change in one or more images.

The system could be designed to have a programmable sensitivity, such that small changes in appearance (e.g. those due changes in lighting, position, movement artifact, etc.) could be ignored.

There has thus been shown and described a novel system for archiving and analysis of video information which fulfills all the objects and advantages sought therefor. Many changes, modifications, variations and other uses and applications of the subject invention will, however, become apparent to those skilled in the art after considering this specification and the accompanying drawings which disclose the preferred embodiments thereof. All such changes, modifications, variations and other uses and applications which do not depart from the spirit and scope of the invention are deemed to be covered by the invention, which is to be limited only by the claims which follow.

What is claimed is:

1. A method of storing digital images, said method comprising the steps of:
a) creating a digital image using a camera, said image consisting of visual data representing visual content of a scene;
b) storing said visual data along with additional information which indicates a position of said camera and a spatial orientation of said camera at the moment when said camera captures said visual data defining said image;
c) moving said camera to another location and repeating steps a) and b);
d) repeating step c) until the desired amount of information is obtained;
thereby to organize and store information about a scene.

2. The method defined in claim 1, wherein said camera moves continuously, while repeatedly capturing said visual data.

3. The method defined in claim 1, wherein said camera position is defined by at least two coordinates in a Cartesian coordinate system.

4. The method defined in claim 1, wherein said camera position is defined by at least two coordinates in a global coordinate system.

5. The method defined in claim 4, wherein said coordinates are determined by a global positioning system.

6. The method defined in claim 1, wherein said camera orientation is defined by at least one coordinate in an angular coordinate system.

7. The method defined in claim 1, wherein said step b) further comprises the storing of information about image magnification, for each image.

8. The method defined in claim 7, wherein said image magnification information is a measure of at least one of (a) optical zoom, and (b) electronic zoom.

9. The method defined in claim 1, wherein said step b) further comprises the storing of information about lighting and shading of a recorded image.

10. The method defined in claim 9, wherein said information about lighting and shading comprises the storing of information concerning at least one of (a) brightness, (b) contrast, (c) white level, and (d) filtering.

11. The method defined in claim 1, wherein said step b) further comprises storing information indicating a moment in time when the camera captures said visual data defining said image.

12. The method defined in claim 1, wherein said scene is at least one of (a) terrain, (b) a landscape, (c) an aerial view, (d) an underwater view, and (e) a view from ground level.

13. The method defined in claim 1, wherein said image is at least one of (a) a face, (b) an interior of a blood vessel of a human body, and (c) an interior of at least one of an esophagus, stomach, intestine, appendix, gall bladder duct, pancreatic duct and hepatic duct; (d) an interior of at least one of a ureter, bladder, fallopian tube, vagina and urethra; and (e) at least one of a human hair and a portion of a head of a human body.

14. The method defined in claim 1, wherein said step b) further comprises the storing of information representing the distance between said camera and at least one object included in said scene.

15. The method defined in claim 14, wherein said distance information is obtained by measuring the time between the transmission from the camera of an energy wave and its return to the camera after reflection from an object in said scene.

16. The method defined in claim 14, wherein said distance information is obtained by the further steps of:
(e) identifying a visible point on an object in a scene recorded in a first image of said scene during a first performance of step (a);
(f) determining a spatial location and direction of the camera to the visible point when creating said first image;
(g) moving the camera to another location;
(h) identifying said visible point on said object recorded in a second image of said scene during a subsequent performance of step (a);
(i) determining a spatial location and direction of the camera to the visible point when creating said second image; and
(j) determining at least one of (1) the position of said visible point with respect to the camera, (2) the spatial coordinates of said visible point.

17. The method defined in claim 14, wherein said distance information is obtained by the further steps of:
(e) identifying a visible point on an object in a scene recorded in a first image of said scene during a first performance of step (a);
(f) determining a spatial location and direction of the camera to the visible point when creating said first image;
(g) determining a first position of said visible point within said first image;
(h) moving the camera to another location;
(i) identifying said visible point on said object recorded in a second image of said scene during a subsequent performance of step (a);
(j) determining a spatial location and direction of the camera to the visible point when creating said second image;
(k) determining a second position of said visible point within said second image; and
(l) determining at least one of (1) the position of said visible point with respect to the camera, (2) the spatial coordinates of said visible point, based on
(A) said first position,
(B) said second position, and
(C) said camera position and orientation information determined during the performance of steps (f) and (j).

18. The method defined in claim 14, wherein said distance information is obtained by the further steps of:
(e) identifying a visible point on an object in a scene recorded in a first image of said scene during a first performance of step (a);
(f) determining a spatial location and direction of the camera to the visible point when creating said first image;
(g) determining at least one first angular coordinate of said point, based on a first position of said point within said first image;
(h) moving the camera to another location;
(i) identifying said visible point on said object recorded in a second image of said scene during a subsequent performance of step (a);
(j) determining a spatial location and direction of the camera to the visible point when creating said second image;
(k) determining at least one second angular coordinate of said point, based on a second position of said point within said second image; and
(l) determining at least one of (1) the position of said visible point with respect to the camera, (2) the spatial coordinates of said visible point, based on
(A) said at least one first angular coordinate,
(B) said at least one second angular coordinate, and
(C) said camera position and orientation information determined during the performance of steps (f) and (j).

19. The method defined in claim 1, further comprising the step of displaying said digital images and said additional information.

20. The method defined in claim 19, further comprising the step of changing at least one of (i) a content, and (ii) a format of said displayed visual data and said additional information.

21. The method defined in claim 20, wherein said changing step includes altering at least one of (i) magnification of at least one image, (ii) brightness of said at least one image, and (iii) contrast of said at least one image.

22. The method defined in claim 1, further comprising the step of displaying a sequence of said digital images, wherein said additional information is used to determine said sequence.

23. The method defined in claim 22, wherein said camera position is defined by at least two coordinates in a Cartesian coordinate system, and wherein said displaying step includes displaying a sequence of images whose camera coordinates define at least one of (i) a line, and (ii) a curve in space.

24. The method defined in claim 22, wherein said camera orientation is defined by at least one coordinate in an angular coordinate system, and wherein said displaying step includes displaying a sequence of images showing the effect of altering said camera orientation.

25. A method of digitally storing images, comprising the steps of:
a) creating two digital images, one from each of two cameras, each respective image consisting of visual data representing visual content of a scene;
b) storing said visual data along with additional information which indicates a position of each camera and a spatial orientation of each camera at the moment when said respective camera captures said visual data defining said image;
c) moving each camera to another location and repeating steps a) and b);
d) repeating step c) until the desired amount of information is obtained;
thereby to organize and store information about an image.

26. The method of claim 25, wherein said two cameras are pointing at the same scene.

27. The method of claim 25, wherein said two cameras are pointing at contiguous regions of the same scene.

28. The method of claim 25, wherein said two cameras create said respective images simultaneously.

29. The method of claim 25, a given parameter is held constant during step (c), said parameter being selected from the group consisting of:
(i) distance between said two cameras;
(ii) difference in angular orientation between said two cameras; and
(iii) a vector extending from one of the two cameras to the other.

30. The method defined in claim 26, wherein said step b) further comprises the step of storing information representing
the distance between said first camera and an object within said scene; and
the distance between said second camera and said object within said scene.

31. The method defined in claim 30, wherein said distance information is obtained by the further steps of:
(e) identifying a visible point on an object in a first image of said scene, created by a first camera during a first performance of step (a);
(f) determining a first position of said point within said first image;
(g) identifying said visible point on said object in a second image of said scene, created by a second camera, substantially simultaneously with the creation of said first image by said first camera;
(h) determining a second position of said point within said second image;
(i) determining at least one of (1) the position of said visible point with respect to the two cameras, (2) the spatial coordinates of said visible point, based on
(A) said first position,
(B) said second position, and
(C) said camera position and orientation information determined during a first performance of step (b).

32. The method defined in claim 30, wherein said distance information is obtained by the further steps of:
(e) identifying a visible point on an object in a first image of said scene, created by a first camera during a first performance of step (a);
(f) determining at least one first angular coordinate of said point, based on a first position of said point within said first image;
(g) identifying said visible point on said object in a second image of said scene, created by a second camera, substantially simultaneously with the creation of said first image by said first camera;
(h) determining at least one second angular coordinate of said point, based on a second position of said point within said second image;
(i) determining at least one of (1) the position of said visible point with respect to the two cameras, (2) the spatial coordinates of said visible point, based on
(A) said at least one first angular coordinate,
(B) said at least one second angular coordinate, and
(C) said camera position and orientation information determined during a first performance of step (b).

33. The method of claim 31, wherein at least one determining step is made in substantially real time.

34. The method of claim 32, wherein at least one determining step is made in substantially real time.

35. The method defined in claim 25, further comprising the step of displaying said digital images created by each of said two cameras.

36. The method defined in claim 35, wherein said display is in a binocular format, thereby to allow a viewing person to have enhanced depth perception when viewing said scene.

37. The method defined in claim 36, further comprising the step of changing at least one of (i) a content, and (ii) a format of said displayed visual data and said additional information.

38. The method defined in claim 24, further comprising the step of displaying a sequence of visual images, wherein said additional information is used to determine said sequence.

39. The method defined in claim 38, wherein each said camera position is defined by at least two coordinates in a Cartesian coordinate system, and wherein said displaying step includes displaying a sequence of images whose respective camera coordinates define at least one of (i) a line, and (ii) a curve in space.

40. The method defined in claim 38, wherein each said camera orientation is defined by at least one coordinate in an angular coordinate system, and wherein said displaying step includes displaying a sequence of images showing the effect of altering said orientation.

41. A method of comparing digitally stored images, comprising the steps of:
a) creating a first digital image using a camera, said image consisting of first visual data representing visual content of a scene;
b) storing said first visual data along with additional information which indicates a position of said camera and a spatial orientation of said camera at the moment when said camera captures said first visual data defining said first digital image;
c) thereafter creating a second digital image using a camera, said image consisting of second visual data representing visual content of substantially the same scene as in step a);
d) storing said second visual data along with additional information which indicates a position of said camera and a spatial orientation of said camera at the moment when said camera captures said second visual data defining said second digital image; and
e) comparing said first digital image with said second digital image;
thereby to determine a change in the content of said scene over a period of time.

42. The method defined in claim 41, wherein said position and spatial orientation of said camera during the creation of said first digital image, is the same as the position and spatial orientation of said camera during the creation of said second digital image.

43. The method defined in claim 41, wherein at least one of:
(i) lighting;
(ii) optical zoom;
(iii) digital zoom;
(iv) white level;
(v) filtering;
(vi) focus;
(vii) choice of lens and
(viii) lens opening,
is the same during the creation of both said first digital image and said second digital image.

44. The method defined in claim 41, further comprising the step of displaying visual data indicating the difference between said first digital image and said second digital image.

45. The method defined in claim 41, further comprising the steps of:
(f) changing at least one of (i) brightness, (ii) contrast, (iii) white level, (iv) digital zoom, (v) magnification, (vi) image position, of at least one of
(1) said first digital image, and
(2) said second digital image; and
(g) displaying visual data indicating the difference between at least one of
(1) said first digital image and a changed version of said second digital image;
(2) said second digital image and a changed version of said first digital image; and
(3) a changed image of said first digital image and a changed version of said second digital image.

46. The method defined in claim 41, wherein the step (e) of comparing said first digital image with said second digital image comprises the steps of:
(1) selecting at least one fiducial point marking a location of a point on an object in the scene shown by said first image;
(2) selecting at least one respective fiducial point marking a location of the same point on the same object selected in step (1), in the scene shown by said second image;
(3) compensating for any differences in at least one of image position and image magnification, between said first image and said second image, based on the position of said fiducial point in said first image and the position of said fiducial point in said second image.
